(19) United States
(12) Patent Application Publication
(10) Pub. No.: US 2021/0097772 A1
(43) Pub. Date: Apr. 1, 2021

(54) CREATION AND MANAGEMENT OF VIRTUAL TWINS USING GEOMETRIC PRIMITIVES

(71) Applicant: Siemens Aktiengesellschaft, Munich (DE)

(72) Inventors: Mareike Kritzler, San Francisco, CA (US); Elvia Kimberly Garcia Garcia, San Francisco, CA (US)

(73) Assignee: Siemens Aktiengesellschaft, Munich (DE)

(21) Appl. No.: 16/585,708

(22) Filed: Sep. 27, 2019

(51) Int. Cl. G06T 19/20; G06T 19/00; G06N 5/02; G06F 3/01; G06F 3/0481; G06F 3/0486

(52) U.S. Cl. CPC G06T 19/20; G06T 19/006; G06F 3/0486; G06F 3/011; G06F 3/04815; G06N 5/022

(57) ABSTRACT

There is described an Augmented Reality system and method thereof for creating and managing a virtual twin of a real-world object, in which the virtual twin includes a virtual part corresponding to an object part of the real-world object. A processor identifies a geometric primitive associated with an object part of the real-world object and associates the virtual part to an attribute of the virtual part. A communication component provides semantic data representing the virtual twin to a knowledge model at a remote server. The semantic data is associated with the virtual part and includes the geometric primitive and the attribute of the virtual part. The geometric primitive includes a geometric shape aligning substantially with an outline of the virtual part and uniform shading provided within the geometric shape.

### FIELD OF THE INVENTION

This application relates to systems for creating and managing virtual twins of real-world objects in digital environments and, more particularly, to an apparatus and method for creation and management of a semantically-supported virtual twin in Augmented Reality.

### BACKGROUND

Augmented Reality (AR) technologies superimpose digital information on real-world objects and display the digital information in the field of view of a user. Augmented Reality applications that utilize these technologies may operate on mobile devices, such as a tablet, head-mounted device, or other wearable devices equipped with a camera and a display. An Augmented Reality application may track real-world objects in order to align or display the digital information alongside or overlay an object. Tracking of the object requires an Augmented Reality application that is capable of identifying the object and providing an augmented camera view of the object at the mobile device. Accordingly, prior knowledge about the object facilitates its recognition by the Augmented Reality application. Vision algorithms may recognize the real-world objects through preprocessing, such as recording of point clouds of real-world objects or manipulation of 3D computer aided drafting (CAD) files.

Semantic technologies are gaining popularity as the amount of raw data needing to be processed and interpreted increases. The objective of Semantic technologies is to add meaning to data models by understanding the nature of the data and their relationship with other pieces of data. Data models may be described as semantic models, knowledge models, or ontologies that include relationships among the models. The data models are semantically described so that the models may be linked to each other and knowledge may be extracted from the ontologies. Many computer-aided design (CAD) programs and CAD files do not semantically describe CAD data, and the CAD data of these designs and files are not linked to existing ontologies.

### SUMMARY

In accordance with one embodiment of the disclosure, there is provided a semantically supported approach for creation and management of a virtual twin for Augmented Reality systems using geometric primitives. The approach enables users to easily create and/or modify a virtual three-dimensional representation of a real-world object, such as a machine or a piece of equipment, as a virtual twin. This approach allows for the use of a virtual model for situations where 3D computer-aided design (CAD) data are not available due to the data being inaccessible (such as confidentiality), unmanageable (such as being too large or complex), or unusable (such as being outdated). The virtual twin allows for barrier-free access at a variety of different physical machines. Thus, a user may utilize the Augmented Reality system to generate complex real-world objects based on geometric primitives. Such primitives become part of the description of the real-world object in an underlying knowledge model. This enriched knowledge model may be further used to help in the creation of three-dimensional models of more complex objects.

One aspect is an Augmented Reality system for creating and managing a virtual twin of a real-world object. The virtual twin includes a virtual part corresponding to an object part of the real-world object. The system comprises a user interface, a processor, and a communication component. The user interface is configured to receive first and second user inputs. The processor is configured to identify a geometric primitive associated with an object part of the real-world object in response to the first user input and associate the virtual part with an attribute of the virtual part in response to the second user input. The geometric primitive includes a geometric shape aligning substantially with an outline of the virtual part and uniform shading provided within the geometric shape. The communication component is configured to provide semantic data representing the virtual twin to a knowledge model at a remote server. The semantic data is associated with the virtual part, and the semantic data includes the geometric primitive and the attribute of the virtual part.

Another aspect is a method of an Augmented Reality system for creating and managing a virtual twin of a real-world object. A geometric primitive is identified as being associated with an object part of the real-world object at an Augmented Reality device. The virtual twin includes a virtual part corresponding to the object part. The virtual part includes the geometric primitive, and the geometric primitive includes a geometric shape aligning substantially with an outline of the virtual part and uniform shading provided within the geometric shape. The virtual part is associated with an attribute of the virtual part at the Augmented Reality device. Semantic data representing the virtual twin is provided to a knowledge model at a remote server. The semantic data is associated with the virtual part, and the semantic data includes the geometric primitive and the attribute of the virtual part.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

The detailed description is set forth with reference to the accompanying drawings. The drawings are provided for purposes of illustration only and. merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is an illustration of an example implementation of an Augmented Reality user experience that is operable to employ techniques described herein.

FIG. 2 is an illustration of another example implementation of an Augmented Reality user experience that is operable to employ the techniques described herein.

FIG. 3 is a block diagram of an example components of an Augmented Reality device that is operable within the Augmented Reality systems of FIGS. 1 and 2.

FIG. 4 is a flow diagram of an example operation for a semantically supported system for creating and managing virtual twins using geometric primitives that employs the techniques described herein.

FIG. 5 is a flow diagram of another example operation for a semantically supported system for managing virtual twins using geometric primitives that employs the techniques described herein.

FIG. 6 is a flow diagram of yet another example operation for a semantically supported system for managing virtual twins using geometric primitives that employs the techniques described herein.

FIG. 7 is a flow diagram of still another example operation for a semantically supported system for managing virtual twins using geometric primitives that employs the techniques described herein.

### DETAILED DESCRIPTION

This disclosure relates to, among other things, devices, servers, systems, methods, computer-readable media, techniques, and methodologies for utilizing semantically-supported virtual twin management, including creation, via geometric primitives in Augmented Reality (AR). While example embodiments of the disclosure will be described herein in connection with Augmented Reality technologies, it should be appreciated that any of a variety of enhanced-reality technologies may be employed including, without limitation, virtual reality technologies, mixed reality technologies, or the like. In accordance with example embodiments of the disclosure, an Augmented Reality (AR) device, such as a head-mounted display, may provide a user interface via which a user may provide gesture based or voice-based input to access and manipulate data in disparate and independent data sources based on queries defined with respect to a semantic information model. User manipulations in the user interface provided by the Augmented Reality device can automatically be reflected by changes to the data values defined by the underlying semantic information model. In addition, the Augmented Reality device may provide a user interface for performing virtual testing of replacement assets with respect to a physical machine in a real-world environment.

Modern industry machines produce a lot of data during their product life cycle, the data resembles the digital twin and its importance for a human user for service, maintenance and repair. The access to this data might be able via a terminal close by, but this access takes time and the match of physical object to data might be prone to errors. In order to match the data and the physical real-world object, Augmented Reality applications can be used. However, a three-dimensional (3D) model of the machine or equipment is needed to apply Augmented Reality technology. Often the 3D model is not available, confidential or too detailed to be useful for Augmented Reality which also makes it too big to be rendered smoothly.

The Augmented Reality systems described herein manage existing real-world objects in Augmented Reality based on simple geometric primitives. The system facilitates the association of geometric primitives with real-world objects, such as the simple act of dragging a geometric primitive to a virtual scene and placing the geometric primitive on a real-world object. The simple and intuitive user interface of the Augmented Reality system provides data access of digital twins and management of Augmented Reality representations of real-world objects. The user interface provides for labelling of sets of geometric primitives as a virtual representation of a part of the real-world object.

For example, a user of the Augmented Reality system may build and manage the user interface for the digital twin from scratch, label the pieces of the interface, and add semantically annotated labels. The system also allows for reuse of existing objects. A user of the Augmented Reality system may easily gain access to the digital twin of the virtual twin, or parts of the virtual twin, with no prior knowledge of CAD files or 3D models associated with the virtual twin.

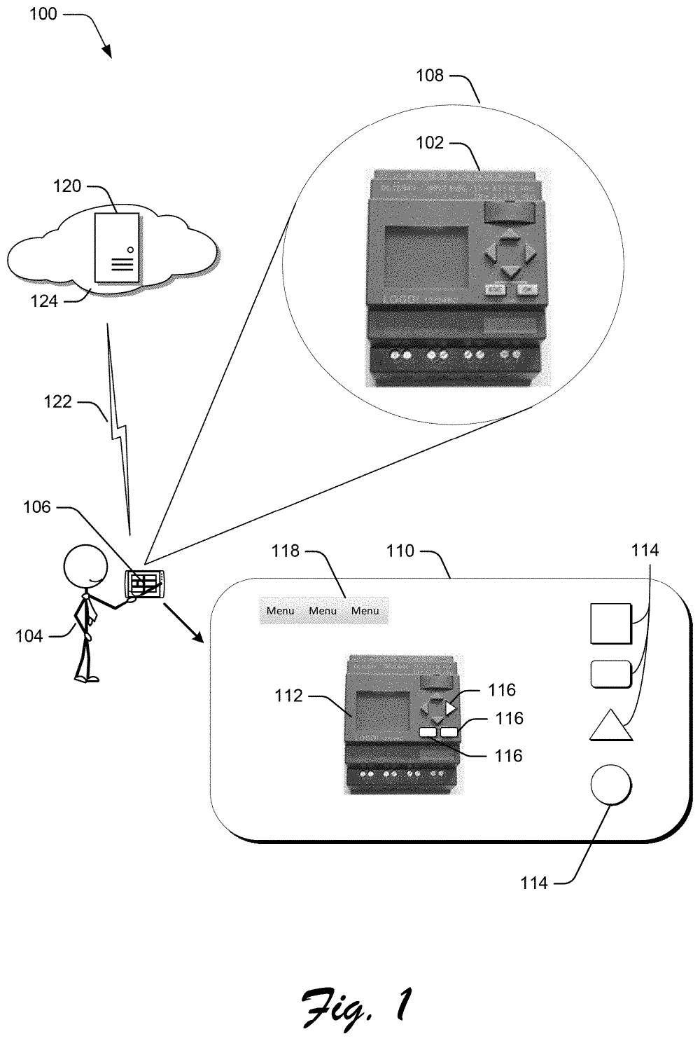

Referring to FIG. 1, there is shown an example implementation of an Augmented Reality user experience for an Augmented Reality system 100. The Augmented Reality system 100 may be used with any type of real-world object 102, and FIG. 1 illustrates this concept with respect to a field device or programmable controller. A user 104 may operate a mobile device 106, such as a tablet, head-mounted device, smartphone, portable computer, and the like. The mobile device 106 includes a camera or other imaging device, which may be directed toward the real-world object 102, as represented directional lines 108, to sense a digital image or representation of the real-world-object.

At a given point in time, the user 104 may observe a display 110 of the mobile device 106 and view an image 112 of the real-world object 102 as well as other information presented by the display. For example, as shown in FIG. 1, the display 110 may provide selectable geometric primitives 114 adjacent to the image 112 as well as selected geometric primitives 116 on, or overlaying, portions of the image. The display 110 may further provide one or more interactive menus or functional buttons 118 to perform actions of the mobile device 106 in relation to the image 112 and its attributes and/or relations. The example implementation of FIG. 1 also shows one or more remote servers 120 in communication with the mobile device 106 via wired or wireless link 122. The remote server or servers 120 may operate independently or as part of a network cloud 124. The remote server(s) 120 may perform operations and analyses on the information collected by the mobile device 106, provide semantic support for the mobile device, and provide output based on the operations, analyses, and support to the mobile device.

The geometric primitives are simplified, less detailed, versions of the parts of the image 112 and the parts of the real-world object 102 corresponding to the image. A geometric primitive is a 2-dimensional (2D) or 3-dimensional (3D) shape, such as a polygon or cube. The geometric primitive may have a location within the virtual twin, an orientation, and/or a scale. In this manner, each geometric primitive acts as a building block or template that may be customized based on user input in order to fit the real-world model.

For some embodiments the selectable and selected geometric primitives 114, 116 may include line drawing of one or more geometric shapes and uniform shading within the line drawings. For example, each geometric primitive 114, 116 may include a geometric shape aligning substantially with an outline of a virtual part. The geometric primitive 114, 116 may be customized based on user input to fit the dimensions, such as 2D or 3D, of a real-world model or object. The geometric primitive 114, 116 may also include uniform shading provided within the geometric shape, such as darkening, coloring, or texturing with uniform lines or at least one block of color. For another example, each geometric primitive 114, 116 may include a second geometric primitive of a second geometric shape corresponding to a portion of the corresponding virtual part and associated with a second object part of the real-world object. The second geometric primitive may include a second geometric shape aligned substantially with a second outline of the virtual part and uniform shading provided within the second geometric shape. Accordingly, each geometric primitive may include one or more attributes such as, but not limited to, a type, location, size, orientation, translation, rotation, scale, color, or texture of the geometric primitive.

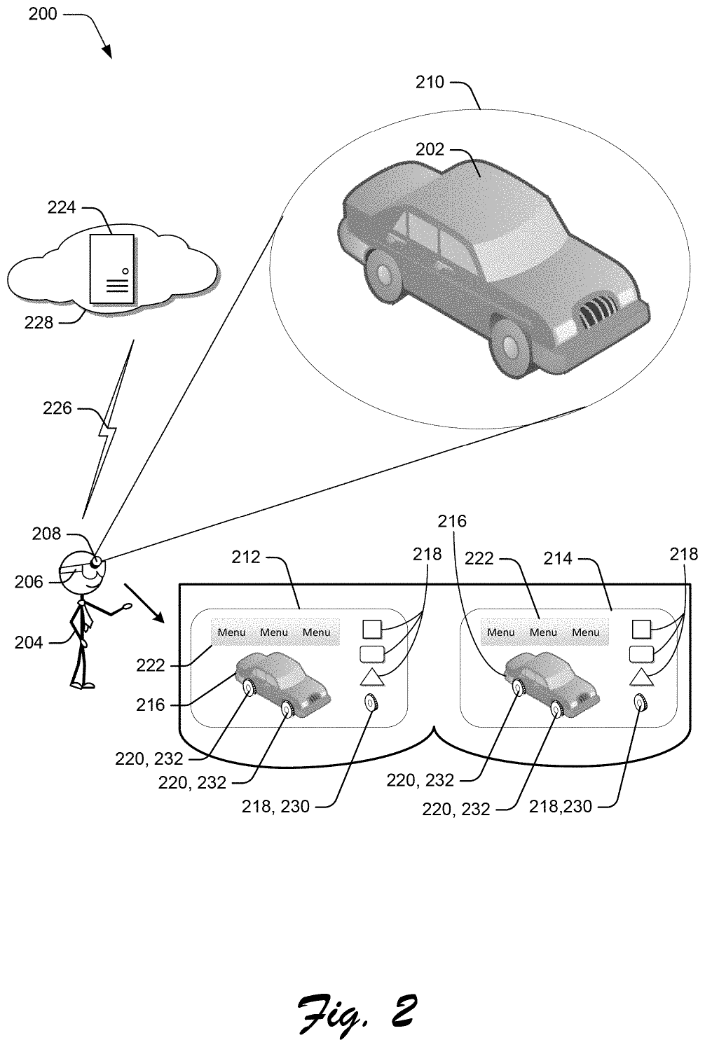

Referring to FIG. 2, there is shown another example implementation of an Augmented Reality user experience for an Augmented Reality system 200. Similar to the Augmented Reality system 100 of FIG. 1, the Augmented Reality system 200 may be used with any type of real-world object 202, and FIG. 2 illustrates this concept with respect to a vehicle. A user 204 may operate a mobile device 206, such as a tablet, head-mounted device, smartphone, portable computer, and the like, and FIG. 2 illustrates the mobile device as a head-mounted device. The mobile device 206 includes a camera or other imaging device 208, which may be directed toward the real-world object 202, as represented directional lines 210, to sense a digital image or representation of the real-world-object.

The user 204 may observe multiple displays 212, 214 of the mobile device 206 and view an image 216 of the real-world object 202. The multiple displays 212, 214 may provide duplicate views of the real-world object 202 or different views providing a 3D effect for the augmented-reality system. The multiple displays 212, 214 may present other information in addition to the image 216 of the real-world object 202. For example, as shown in FIG. 2, the displays 212, 214 may provide selectable geometric primitives 218 adjacent to the image 216 as well as selected geometric primitives 220 on, or overlaying, portions of the image. The displays 212. 214 may further provide one or more interactive menus or functional buttons 222 to perform actions of the mobile device 206 in relation to the image 216 and its attributes and/or relations.

Similar to the Augmented Reality system 100 of FIG. 1, the geometric primitives of the Augmented Reality system 200 of FIG. 2 are simplified, less detailed, versions of the parts of the image 216 and the parts of the real-world object 202 corresponding to the image. The selectable and selected geometric primitives 218, 220 may include line drawings based. on geometric shapes and uniform shading within the line drawings. The selectable and selected geometric primitives 218, 220 may include an outline or boundary similar to the outline or boundary of a part of the image 216 and/or a part of the real-world object 202 corresponding to the image. For example, a particular selectable primitive 230 and a. particular selected geometric primitive 232 illustrated in FIG. 2 include the outline or boundary of a tire for the vehicle.

The example implementation of FIG. 2 also shows one or more remote servers 224 in communication with the mobile device 206 via wired or wireless link 226. The remote server or servers 224 may operate independently or as part of a network cloud 228. The remote servers) 224 may perform operations and analyses on the information collected by the mobile device 206, provide semantic support for the mobile device, and provide output based on the operations, analyses, and support to the mobile device. In particular, the remote server(s) 224 include ontology applications configured to manage a knowledge model and focus on models instead of lines of codes. The ontology of the ontology applications is a data model representing knowledge as a set of concepts within a domain and the relationships between these concepts, within an organization or enterprise. The ontologies may be constructed based on one or more standards, such as a resource description framework (RDF) and a web ontology language (OWL).

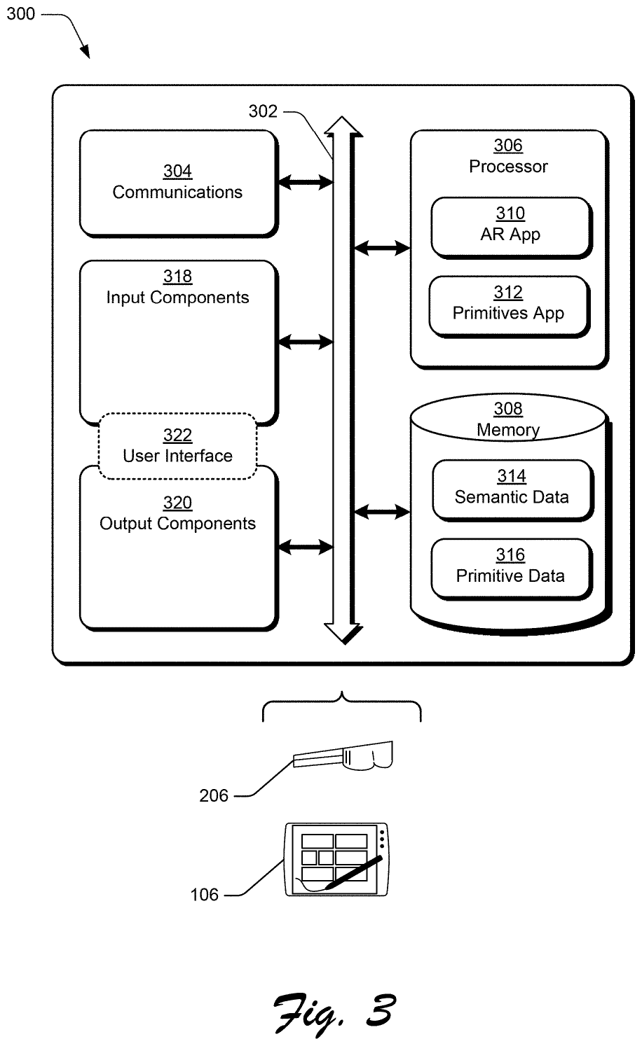

FIG. 3 represents example device components 300 of a typical Augmented Reality device 106, 206 of the Augmented Reality system 100, 200. An example of an Augmented Reality device 106, 206 includes, but is not limited to, a tablet, head-mounted device, smartphone, portable computer, or any other type of visual input and output device having a communications capability with a remote server or cloud. The device components 300 comprise a communication bus 302 for interconnecting the other device components directly or indirectly, one or more communication components 304 communicating other entities of the alarm system via a wired or wireless link, one or more processors 306, and one or more memory components 308. The communication component 304 of the device components 300 may also utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology. The communication component 304 may also, or in the alternative, utilize wired technology for communication, such as transmission of data over a physical conduit, an electrical wire, electrical cable, or optical fiber.

The processor 306 may execute code and process data received other components of the device components 300, such as information received at the communication component 304 or stored at the memory component 308. The code associated with the Augmented Reality device 106, 206 and stored by the memory component 308 may include, but is not limited to, operating systems, applications, modules, drivers, and the like. An operating system includes executable code that controls basic functions of the Augmented Reality device, such as interactions among the various components of the device components 300, communication with external devices via the communication component 304, and storage and retrieval of code and data to and from the memory component 308. Each application includes executable code to provide specific functionality for the processor 306 and/or remaining components of the Augmented Reality device. Examples of applications executable by the processor 306 include, but are not limited to, an Augmented Reality application 310 to manage general operations of an Augmented Reality device and a geometric primitives application 312 (which may be integral to or separate from the Augmented Reality application) to manage the creation, manipulation, and transfer of geometric primitives. Data is information that may be referenced and/or manipulated by an operating system or application for performing functions of the intermediate device. Examples of data associated with the Augmented Reality system 100, 200 and stored by the memory component 308 may include, but are not limited to, semantic data 314 including semantic data associated with virtual twins and attributes of the virtual twins as well as parts/assembly labels, and geometric primitive data 316 (which may be integral to or separate from the semantic data) associated with geometric primitives and attributes of the geometric primitives which are all modeling real-world objects and object parts.

The device components 300 of Augmented Reality device 106, 206 may include one or more input components 318 and/or one or more output components 320. The input components 318 and the output components 320 of the device components 400 may include one or more visual, audio, mechanical, and/or other components.

For some embodiments, the input components 318 and the output components 320 of the Augmented Reality device 106, 206 may comprise a user interface 322 for interaction with a user of the Augmented Reality device. The user interface 322 may include a combination of hardware and software to provide a user with a desired user experience. For example, the user interface 322 may include one or more input components 318 to allow the user to label elements, arrange primitives, and manage assemblies via touchscreen, gesture, or voice input, and one or more output components 320 to provide feedback and semantic data to the user via display or voice audio. Although the user interface 322 may include all input components 318 and all output components 320, the user interface may also be directed to a specific subset of input components and/or output components.

It is to be understood that FIG. 3 is provided for illustrative purposes only to represent examples of the device components 300 of an Augmented Reality device 106, 206 and is not intended to be a complete diagram of the various components that may be utilized by the appliance. Therefore, Augmented Reality device 106, 206 may include various other components not shown in FIG. 3, may include a combination of two or more components, or a division of a particular component into two or more separate components, and still be within the scope of the present invention.

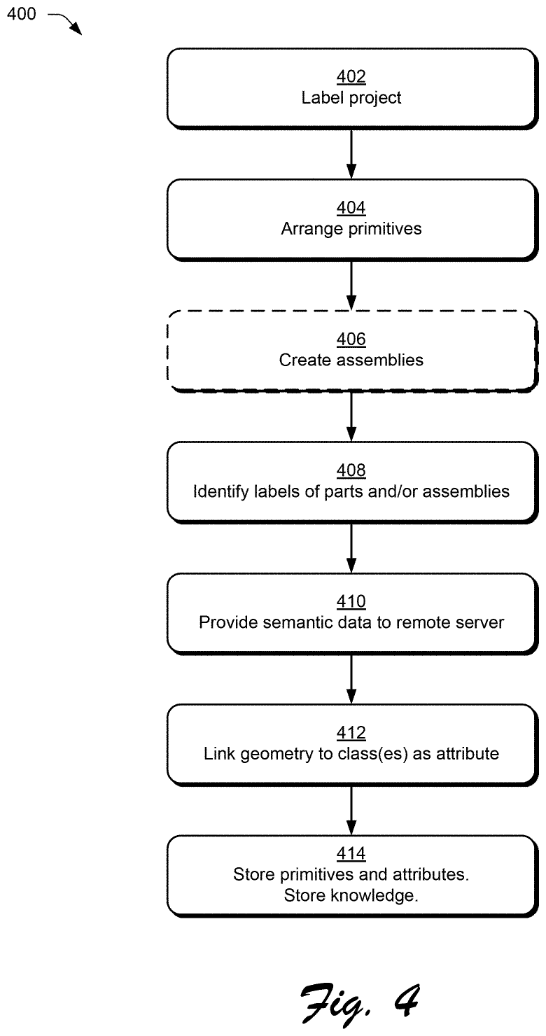

Referring to FIG. 4, there is shown a flow diagram of a first use case 400 for a semantically supported system that manages virtual twins using geometric primitives in an Augmented Reality system. For this first use case 400, 3D CAD data are not available due to the data being inaccessible, unmanageable, or unusable. Also, the real-world object is known by the human user but there is no primitive CAD model or knowledge available.

For the first use case 400, the primitive CAD model and the knowledge model are created. A project is initiated 402 at the Augmented Reality device 106, 206. In particular, the Augmented Reality device 106, 206 identifies a project associated with the virtual twin. The Augmented Reality device 106, 206 then identifies 404 a geometric primitive associated with an object part of the real-world object in response to a first user input. For this identification, an output component 320, such as a display, of the Augmented Reality device 106, 206 may arrange at least a portion of a geometric primitive over the virtual part of the virtual twin corresponding object part of the real-world object in response to the first user input. For example, at least a portion of the geometric primitive may be dragged-and-dropped over the representation of the real-world part, e.g., the virtual part of the virtual twin. Each geometric primitive includes a geometric shape aligning substantially with an outline of the corresponding virtual part and uniform shading provided within the geometric shape.

After identifying 404 the geometric primitive associated with the virtual part, the Augmented Reality device 106, 206 may generates 406 an assembly of two or more of virtual parts of the virtual twin, when necessary, in response to a second user input. For some embodiments, the assembly may be associated with the geometric primitives of the two or more virtual parts. An assembly is a part that is composed of multiple parts or components. For example, to generate a vehicle wheel, one may start with a tire (by adding a shape), then add another shape as the rim, select the shapes for the rim and tire, and aggregate these shapes as a wheel object. Accordingly, the wheel would have the tire and rim as attributes. Next, the Augmented Reality device 106, 206, or the processor 306 of the device, may associate 408 the virtual part with an attribute of the virtual part in response to a third use input. For example, the attribute of the virtual part may include a part label identifying the virtual part.

After the primitive is identified and the attribute of the virtual part is associated, the Augmented Reality device 106, 206 provides 410 semantic data associated with the virtual twin to a knowledge model at a remote server 120, 224. It is to be understood that reference to the remote server 120, 224 includes the cloud 124, 228 and any devices/servers associated with the cloud. The semantic data is associated with the virtual part, and the semantic data includes the geometric primitive and the attribute of the virtual part. For example, the semantic data may include an assembly label identifying the assembly if one exists.

The remote server 120, 224 may then link 412 the geometric primitives to one or more classes, such as newly created classes, as an instance. When linking 412 the geometric primitives to the instance of the classes, the remote server 120, 224 may add other attributes such as a location of each geometric primitive and a size of each geometric primitive. Thereafter, the remote server 120, 224 may store 414 the geometric primitives and the attributes of the geometric primitives as well as one or more ontologies for the knowledge model.

For some embodiments, in reference to all use cases, each geometric primitive may include a second geometric primitive of a second geometric shape corresponding to a portion of the corresponding virtual part and uniform shading provided within the second geometric shape. The second geometric primitive is associated with a second object part of the real-world object, and the second geometric primitive includes a second geometric shape aligning substantially with a second outline of the virtual part and uniform shading provided within the second geometric shape. For some other embodiments, in reference to all use cases, each geometric primitive may include a second geometric primitive of a second geometric shape corresponding to one or more sub-parts of the corresponding virtual part and uniform shading provided within the second geometric shape. The semantic data may further include data associated with to the real-world object and attributes of the real-world object. Thus, the primitive CAD model is created from geometric primitives and a knowledge model skeleton is created as well.

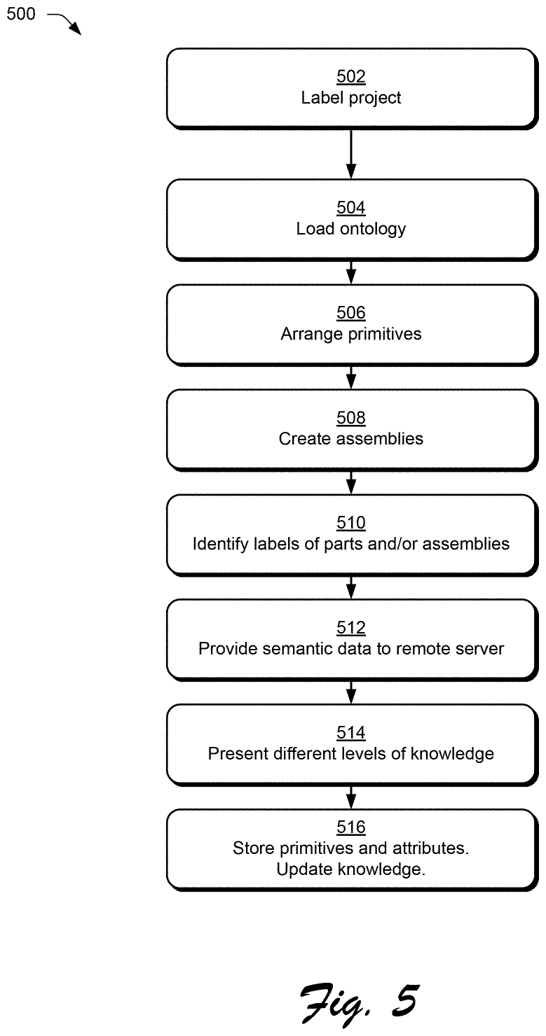

Referring to FIG. 5, there is shown a flow diagram of a second use case 500 for a semantically supported system that manages virtual twins using geometric primitives in an Augmented Reality system. For this second use case 500, 3D CAD data are not available due to the data being inaccessible, unmanageable, or unusable. Also, the real-world object is known and a knowledge model is available, but there is no primitive CAD model.

For the second use case 500, the primitive CAD model is created and the knowledge model is updated. A project is initiated 502 at the Augmented Reality device 106, 206. In particular, the Augmented Reality device 106, 206 identifies a project associated with the virtual twin that will be created based on the real-world object. In response to initiating 502 the project, the Augmented Reality system may recognize the object and loads 504 an ontology that includes one or more parts of the object to be created virtually. In particular, ontology data of the knowledge model may be transferred from the remote server 120, 224 to the Augmented Reality device before identifying the geometric primitive associated with the object part of the real-world object. It is to be understood that reference to the remote server 120, 224 includes the cloud 124, 228 and any devices/servers associated with the cloud.

After loading 504 the ontology, the Augmented Reality device 106, 206 may identify 506 a geometric primitive associated with the object part of the real-world object in response to a first user input. For this identification, an output component 320, such as a display, of the Augmented Reality device 106, 206 arranges at least a portion of a geometric primitive over the corresponding virtual part of the virtual twin corresponding to the object part of the real-world object in response to the first user input. For example, at least a portion of the geometric primitive may be dragged-and-dropped over the representation of the real-world part, i.e., virtual part, of the representation of the real-world object, i.e., virtual twin.

After identifying 506 the geometric primitive with the virtual part, the Augmented Reality device 106, 206 may generate 508 an assembly of two or more of virtual parts when necessary. Next, the Augmented Reality device 106, 206 may labels parts and/or assemblies. In particular, the attribute of the virtual part may include a part label of the virtual part and/or an assembly label identifying the assembly.

After the primitive is identified and the attribute of the virtual part is associated, the Augmented Reality device 106, 206 provides 512 semantic data associated with the virtual twin to a knowledge model at a remote server 120, 224. The semantic data is associated with the virtual part, and the semantic data includes the geometric primitive and the attribute of the virtual part. For example, the semantic data may include an assembly label identifying the assembly if one exists.

The remote server 120, 224 may then present 514 and determine different levels of knowledge detail to help build the primitive CAD model. For example, the remote server 120, 224 may build a primitive CAD model for a complete motor and/or directed to cylinders of the motor. Thereafter, the remote server 120, 224 may store 516 the geometric primitives and the attributes of the geometric primitives and update one or more ontologies for the knowledge model. Thus, a rich ontology is used to assist the creation of the primitive CAD model of the real-world object.

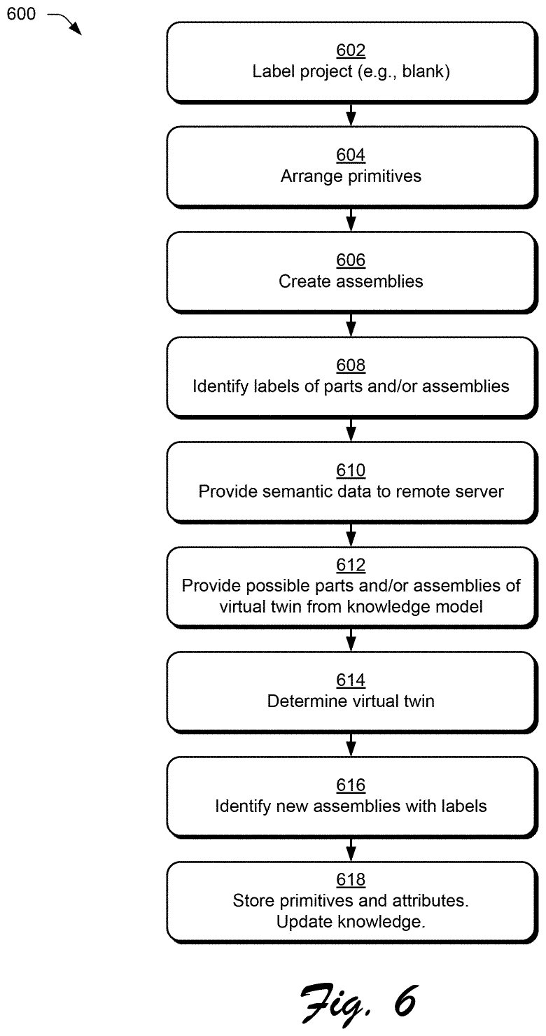

Referring to FIG. 6, there is shown a flow diagram of a third use case 600 for a semantically supported system that manages virtual twins using geometric primitives in an Augmented Reality system. For this third use case 600, 3D CAD data are not available due to the data being inaccessible, unmanageable, or unusable. Also, parts of the real-world object are recognized and a knowledge model is available, but the real-world object is not known and there is no primitive CAD model.

For the third use case 600, the primitive CAD model is created and the knowledge model is updated. A blank project is initiated 602 at the Augmented Reality device 106, 206. In particular, the Augmented Reality device 106, 206 identifies a project associated with the virtual twin as a blank project. After initiating 602 the project, the Augmented Reality device 106, 206 may identify 604 a geometric primitive associated with an object part of the real-world object in response to a first user input. For this identification, an output component 320, such as a display, of the Augmented Reality device 106, 206 arranges at least a portion of a geometric primitive over the corresponding virtual part of the virtual twin corresponding to the object part in response to the first user input. For example, a portion of the geometric primitive may be dragged-and-dropped over the virtual part of the virtual twin.

After identifying 604 the geometric primitive with the virtual part, the Augmented Reality device 106, 206 may generates 606 an assembly of two or more of virtual parts when necessary. For some embodiments, the assembly may be associated with the geometric primitives of the two or more virtual parts. Next, the Augmented Reality device 106, 206 labels parts and assemblies. In particular, the attribute of the virtual part may include a part label identifying the virtual part and/or an assembly label identifying the assembly.

After the primitive is identified 604, the Augmented Reality device 106, 206 may provide 610 semantic data representing the virtual twin to a knowledge model at a remote server 120, 224. It is to be understood that reference to the remote server 120, 224 includes the cloud 124, 228 and any devices/servers associated with the cloud. The semantic data may be associated with the virtual part, and the semantic data may include the geometric primitive and the attribute of the virtual part. The remote server 120, 224 may then provide 612 possible parts and/or assemblies of the virtual twin from the knowledge model. For example, the Augmented Reality system may explore the knowledge model to suggest other assemblies and/or parts that may also be part of the virtual twin. In response to providing 612 these possibilities, the remote server 120, 224 may determine 614 the virtual twin and/or corresponding real-world object. The Augmented Reality system may identify the virtual twin and/or corresponding real-world object after multiple iterations of exploration. The Augmented Reality system may act as an assistant or digital companion and support the user during the creation or modification process. For example, the semantic system may suggest parts to add to the virtual twin based on existing parts or parts previously added.

In response to determining 614 the virtual twin and/or the real-world object, the remote server 120, 224 may identify 616 new assemblies with labels. After object identification, if a user indicates a creation of one or more new assemblies and initiates corresponding labels for the new assemblies, then the Augmented Reality system verifies that the labels are appropriate for the object. For example, the Augmented Reality system may compare a given label to the subject object to determine whether their classifications match or if it is part of the whole object. Thereafter, the remote server 120, 224 may store 618 the geometric primitives and the attributes of the geometric primitives and update one or more ontologies for the knowledge model. Thus, a rich ontology is used to assist in the identification of the real-world object and the creation of its primitive CAD model.

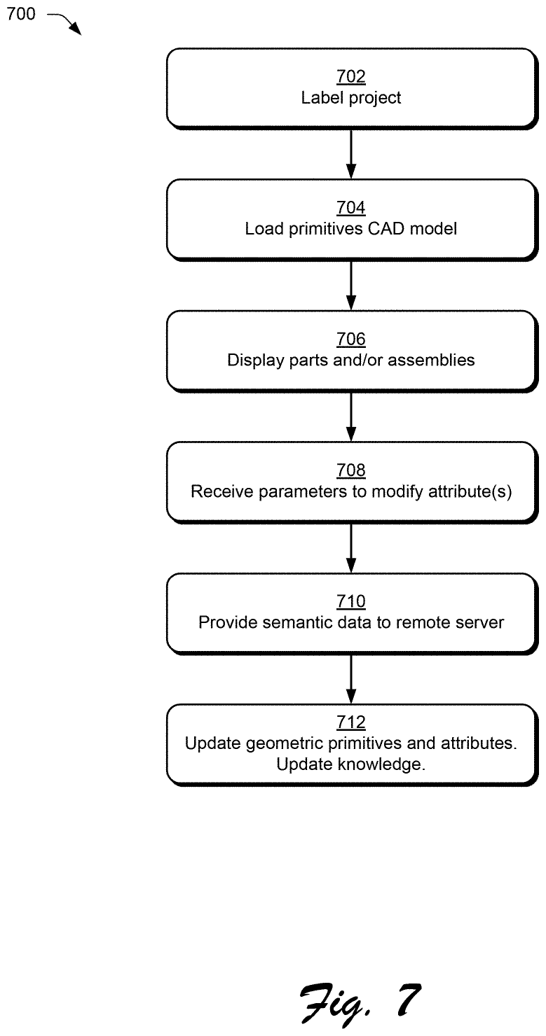

Referring to FIG. 7, there is shown a flow diagram of a fourth use case 700 for a semantically supported system that manages virtual twins using geometric primitives in an Augmented Reality system. For this fourth use case 700, detailed 3D CAD data are not available due to the data being inaccessible, unmanageable, or unusable but a primitive CAD model. Also, the real-world object and its parts are known, and a knowledge model and a primitive CAD model are available.

For the fourth use case 700, the primitive CAD model and the knowledge model may be updated, if necessary. A project is initiated 702 at the Augmented Reality device 106, 206. In particular, the Augmented Reality device 106, 206 identifies a project associated with the virtual twin. After initiating 702 the project, the Augmented Reality device 106, 206 loads 704 one or more primitives and attributes of the primitives from the remote server 120, 224. It is to be understood that reference to the remote server 120, 224 includes the cloud 124, 228 and any devices/servers associated with the cloud. The geometric primitive data of a primitive CAD model may be transferred 704 from the remote server to the Augmented Reality device before identifying the geometric primitive associated with the object part of the real-world object. The attributes of the geometric primitive may include one or more of a type, location, size, translation, rotation, scale, color, and/or texture of the geometric primitive.

After transferring 704 the primitives and the attributes of the primitives, the Augmented Reality device 106, 206 may display 706 parts and/or assemblies, if available, based on the loaded primitives and attributes of the primitives. The Augmented Reality device 106, 206 may display descriptions associated with the parts and/or assemblies. In response to displaying 706 the parts and/or assemblies, the Augmented Reality device 106, 206 may receive 708 user input at the user interface associated with parameters to modify one or more attributes of the primitives. The user input represents a user's request to parametrize attributes of the primitive CAD model.

In response to receiving 708 parameters for modifying one or more attributes of the primitives, the Augmented Reality device 106, 206 provides 710 semantic data associated with the virtual twin to a knowledge model at a remote server 120, 224. The semantic data may be associated with the virtual part, and the semantic data may include the geometric primitive and/or attributes of the virtual part. The remote server 120, 224 may, thereafter, update 712 the geometric primitive and/or the attributes of the virtual part. In particular, the remote server 120, 224 stores the parametrized objects in the knowledge model as instances with different characteristics, such as change of color, change of size, and the like. The attribute of the virtual part includes a part label identifying the virtual part. The remote server 120, 224 may also update one or more ontologies for the knowledge model. Thus, the Augmented Reality system may take advantage of an already existing knowledge base of objects and their corresponding primitive CAD model.

The operations described and depicted in the illustrative methods of FIGS. 1 through 7 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1 through 7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular Augmented Reality device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field- programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. An Augmented Reality system for creating and managing a virtual twin of a real-world object, comprising:
a user interface configured to receive first and second user inputs;
a processor configured to identify a geometric primitive associated with an object part of the real-world object in response to the first user input and, wherein the virtual twin includes a virtual part corresponding to the object part, the virtual part being associated with an attribute of the virtual part in response to the second user input; and
a communication component configured to provide semantic data representing the virtual twin to a knowledge model at a remote server, the semantic data being associated with the virtual part and including the geometric primitive and the attribute of the virtual part,
wherein the geometric primitive includes a geometric shape aligning substantially with an outline of the virtual part and uniform shading provided within the geometric shape.

2. The Augmented Reality system as described in claim 1, wherein:
the user interface receives a third user input;
the processor generates an assembly of two or more virtual parts of the virtual twin in response to the third user input, the semantic data including an assembly label identifying the assembly.

3. The Augmented Reality system as described in claim 1, wherein:
the user interface is configured to arrange at least a portion of the geometric primitive over the virtual part corresponding to the object part.

4. The Augmented Reality system as described in claim 3, wherein the user interface is effective to drag-and-drop at least a portion of the geometric primitive over the virtual part of the virtual twin.

5. The Augmented Reality system as described in claim 1, wherein the processor identifies a second geometric primitive associated with a second object part of the real-world object, the second geometric primitive including a second geometric shape aligned substantially with a second outline of the virtual part and uniform shading provided within the second geometric shape.

6. The Augmented Reality system as described in claim 1, wherein the geometric primitive includes a second geometric shape corresponding to at least one sub-part of the virtual part and uniform shading provided within the second geometric shape.

7. The Augmented Reality system as described in claim 1, wherein the communication component transfers ontology data of the knowledge model from the remote server to the Augmented Reality device before the processor identifies the geometric primitive associated with the object part of the real-world object.

8. The Augmented Reality system as described in claim 1, wherein the communication component transfers geometric primitive data of a primitive CAD model from the remote server to the Augmented Reality device before the processor identifies the geometric primitive associated with the object part of the real-world object.

9. The Augmented Reality system as described in claim 1, wherein the attribute of the virtual part includes a part label identifying the virtual part.

10. The Augmented Reality system as described in claim 1, wherein the geometric primitive includes at least one attribute selected from a group consisting of a type, location, size, orientation, translation, rotation, scale, color, or texture of the geometric primitive.

11. A method of an Augmented Reality system for creating and managing a virtual twin of a real-world object, comprising:
identifying, at an Augmented Reality device, a geometric primitive associated with an object part of the real-world object in response to a first user input, the virtual twin including a virtual part corresponding to the object part, the geometric primitive having a geometric shape aligning substantially with an outline of the virtual part and uniform shading provided within the geometric shape;
associating, at the Augmented Reality device, the virtual part with an attribute of the virtual part in response to a second user input; and
providing semantic data representing the virtual twin to a knowledge model at a remote server, the semantic data being associated with the virtual part and including the geometric primitive and the attribute of the virtual part.

12. The method as described in claim 11, further comprising:
generating an assembly of two or more virtual parts of the virtual twin, the semantic data including an assembly label identifying the assembly.

13. The method as described in claim 11, wherein identifying the geometric primitive with the object part of the real-world object includes arranging, at a user interface of the Augmented Reality device, at least a portion of the geometric primitive over the virtual part corresponding to the object part.

14. The method as described in claim 13, wherein arranging at least the portion geometric primitive over the virtual part includes dragging-and-dropping, at the user interface of the Augmented Reality device, at least a portion of the geometric primitive over the virtual part of the virtual twin.

15. The method as described in claim 11, further comprising identifying, at the Augmented Reality device, a second geometric primitive associated with a second object part of the real-world object, the second geometric primitive including a second geometric shape aligning substantially with a second outline of the virtual part and uniform shading provided within the second geometric shape.

16. The method as described in claim 11, wherein the geometric primitive includes a second geometric shape corresponding to at least one sub-part of the virtual part and uniform shading provided within the second geometric shape.

17. The method as described in claim 11, further comprising transferring ontology data of the knowledge model from the remote server to the Augmented Reality device before identifying the geometric primitive associated with the object part of the real-world object.

18. The method as described in claim 11, further comprising transferring geometric primitive data of a primitive CAD model from the remote server to the Augmented Reality device before identifying the geometric primitive associated with the object part of the real-world object.

19. The method as described in claim 11, wherein the attribute of the virtual part includes a part label identifying the virtual part.

20. The method as described in claim 11, wherein the geometric primitive includes at least one attribute selected from a group consisting of a type, location, size, orientation, translation, rotation, scale, color, or texture of the geometric primitive.
